(19) United States
(12) Patent Application Publication
(10) Pub. No.: US 2012/0308689 A1
(43) Pub. Date: Dec. 6, 2012

(54) METHOD FOR PRODUCING PLASTIC CONTAINERS BY STRETCH BLOW MOLDING, PREFORM, CONTAINER AND USE OF SUCH A CONTAINER

(75) Inventors: Francoise Poulat, Sciez (FR); Jean-Paul Besson, Abondance (FR); Emilie Boutin, Evian-Ies-Bains (FR)

(73) Assignee: SA DES EAUX MINERALES D'EVIAN SAEME, Evian-les-Bains (FR)

(21) Appl. No.: 13/579,141

(22) PCT Filed: Mar. 11, 2011
(86) PCT No.: PCT/EP2011/053679

§ 371 Date: Aug. 15, 2012

(30) Foreign Application Priority Data
Mar. 11, 2010 (IB) PCT/IB2010/001116

(51) Int. Cl. B65D 85/72; B32B 1/00; B65D 1/02; B29C 49/10

(52) U.S. Cl. 426/106; 264/532; 428/36.92; 215/40

(57) ABSTRACT

Hollow plastic containers provided with a narrow opening and a body having a base and at least one side wall extending longitudinally between the narrow opening and the base, such as bottles or similar, are obtained from preforms by stretch blow molding. A blend of polyethylene terephtalate (PET) and polytrimethylene terephtalate (PTT), with a weight proportion of PTT in the range 5-50% is injected to obtain the preform. During the stretch blow molding step, the multi polyester preform undergoes longitudinal stretching at a longitudinal ratio of between approximately 3.5 and 6 and radial stretching at a ratio of between approximately 4 and 9. The body of the preform is subjected to an overall stretching ratio included between 16 and 50, whereby the weight of the container produced by stretch-blow molding may be reduced.

### FIELD OF THE INVENTION

The present invention relates generally to improvements made in the field of the production of containers comprising a narrow opening and a long body, such as bottles or similar, by means of stretch blow molding preforms containing PET. The invention may be applied in particular in injection stretch-blow molding method (ISBM).

### BACKGROUND OF THE INVENTION

It is known to produce containers, and in particular bottles or similar, by means stretch blow molding from preforms made from various materials. The technology ISBM is well known and comprises at first injecting the material by:
optionally drying (if necessary) the material to be used before any fusion,
plasticizing the material,
injecting the plasticized material in the mold, which may consist of a core and one counter mold that form a molding cavity,
cooling the material shaped into a preform,
stripping with evacuation of the preform.

Then a blowing is performed, the blowing including following steps: reheating of preforms, stretching-preblowing and blowing.

The material which is used most frequently nowadays is polyethylene terephthalate (PET) due to certain very advantageous properties of bottles made from this material (namely their good mechanical resistance, allowing them to contain carbonated drinks, the facility to be filled with a hot liquid, the good transparency of the PET which does not adversely affect the appearance of the liquid which they contain, a relatively good barrier effect to oxygen, etc.).

While Extrusion blow molding (EBM) machines are much cheaper, ISBM equipment is often preferred to obtain plastic containers such as PET bottles from preforms because the PET containers made by the ISBM method are stronger, lighter, have better clarity, and are leak proof (injection molded neck) than anything else possible by the EBM method. Some containers can only be made by ISBN, soft drinks bottles for example cannot be molded by EBM. The average thickness of the container side wall may be typically inferior to 300 μm when produced by means of stretch-blow molding.

Nevertheless, the weight of the PET bottles cannot be easily reduced since the PET preforms have to be injected properly and without any deformation and stretched so as to obtain uniform shapes. Problems caused by the high injection pressures with preforms having thin walls are mentioned in Patent application FR2898293-A1 of the Applicant.

With the conventional ISBM equipments, attempts made to highly reduce the thickness of PET containers comprising a narrow opening and a long body have resulted in failure (in particular problems during molding due to high injection pressure, non-uniform shapes from one container to the other and apparition of “short shots” with a lack of material in area(s) at the opposite of the material injection point). Indeed, following research undertaken in this field, the applicant has been able to establish that, to obtain satisfactory containers comprising a narrow opening and a body of a standard capacity of 500 mL, with mass production and with production equipment operating at a high rate, it was necessary to have an average thickness of the preform body not inferior to 2 mm. The phrase “container comprising a narrow opening and a long body”, in the remainder of the present description, is understood to be any container of which the opening has a smaller section than that of its body: this may be a bottle or a similar container such as a can, flask or similar, which has a narrow neck or mouth.

There are already some solutions to provide to the consumers containers with less thick walls and thus containing less material through mixing of PET with aromatic polyester. The patent EP1436203 concerns containers obtained by an ISBM method where PET is mixed with an amorphous aromatic polyester such as PEN (polyethylene naphtalate). However, this method is not adapted for containers such as bottles with a conventional shape, including a rigid bottom or similar base and one or more side walls allowing the bottle to be easy manipulated and transported.

### SUMMARY OF THE INVENTION

The present invention is aimed at alleviating the disadvantages of the known ISBM methods and its purpose is to supply a preform which allow producing a container comprising a narrow opening and a long body which, for the same volume, requires less plastic than a standard container obtained by an ISBM method.

To this end, embodiments of the present invention provide a method for producing containers comprising a narrow opening and a body having a base and at least one side wall extending longitudinally between the narrow opening and the base, by stretch-blow molding an injection-molded preform that comprises a body, characterized in that the body of the preform comprises, preferably essentially comprises, 50-95 wt % of PET and 5-50 wt % of PTT, and in that the body of the preform is subjected to an overall stretching ratio comprised between 16 and 50, the overall stretching ratio being the product of a longitudinal stretching ratio L/l and a radial stretching ratio D/d, where

L is the developed half length L of said body of the container;
l is the developed half length l of the body of the preform;
D is the average diameter of said body of the container; and
d is the average diameter d of the body of the preform.

The body comprises 50-95 wt % of PET and 5-50 wt % of PTT. In other words, the body is made of a material, typically a plastic composition, comprising 50-95 wt % of PET and 5-50 wt % of PTT. The material can essentially comprise 50-95 wt % of PET and 5-50 wt % of PTT. The material can essentially consist of 50-95 wt % of PET and 5-50 wt % of PTT. In one embodiment the material consists of 50-95 wt % of PET and 5-50 wt % of PTT.

Surprisingly, the use of PTT does not affect the molding workability by stretch blow-molding of the preform and the biaxial stretching rate is highly increased. This was unexpected as PTT was not used in ISBM methods because of its high tendency to crystallize (a crystallized polymer is rigid and can neither be molded, nor stretched by a blowing gas). By working with a plastic material, for example with PET, by stretch blow molding, the above mentioned stretching ratio is limited, while keeping a good integrity of the container.

Advantageously with this method, the operating rate of the ISBM production equipment is not reduced (i.e. with the same rate as for the production of the conventional PET containers). Thanks to the high overall stretching ratio (also called biaxial ratio), a preform having a wall thickness not inferior to 2 mm may be used to obtain the container of lower weight.

One further advantage of PTT is that it can be based on renewable resources and thus minimizes the depletion of oil, which is a non-renewable resource.

In one embodiment the material comprises 75-95 wt % of PET and 5-25 wt % of PTT. In one embodiment the material essentially comprises 75-95 wt % of PET and 5-25 wt % of PTT. In one embodiment the material essentially consists of 75-95 wt % of PET and 5-25 wt % of PTT. In one embodiment the body consists of 75-95 wt % of PET and 5-25 wt % of PTT.

The preferred amounts mentioned above can be typically in the ranges below:
90-95 wt % PET and 5-10% PTT, or
85-90 wt % PET and 10-15% PTT, or
80-85 wt % PET and 15-20% PTT, or
75-80 wt % PET and 20-25% PTT.

The material can comprise a crystallization accelerator or a nucleating agent. In one embodiment the material does not comprise a crystallization accelerator or a nucleating agent.

The material can comprise optional additives such as colouring agents, plasticizers, stabilisation agents, for example antioxidants, anti-static agents, lubricants, processing aids, fire-retardants, charges and fillers. Such additives are known by the one skilled in the art.

These additives can be to the mixture the mixture of PET and PET, or to the PET or the PTT, before mixing the PET and the PTT.

The material having the mixture of PET and PTT can be obtained by melting and mixing the PET and the PTT, or compositions comprising the PET and the PTT, for example by melting and mixing plastic chips. In one embodiment the material is formed before production of the preform, by melting, mixing, extruding to obtain a material in the form of chips, flakes, pellets or powder. These are then typically used in the method of the invention, to form the injection molded perform. In one embodiment the material is formed during production of the preform, by separate introduction during the injection molding of the PET and the PTT, or compositions comprising the PET and the PTT, for example in the form of plastic chips.

According to a particular feature, the body of the preform comprises, preferably essentially comprises, 75-95 wt % of PET and 5-25 wt % of PTT, the body of the preform being subjected to an overall stretching ratio comprised between 16 and 25. With such a composition for the preform, an advantageous compromise is obtained for producing bottles or similar containers having mechanical resistance adapted for good formability. In particular, the containers may be shaped as the conventional PET containers with an elongated body and a bottom sufficiently rigid to support weight of the content (typically more than 300 mL water), the bottom allowing a vertical storage of the container. This composition of the preform is suitable for producing 250-2000 mL containers, while a higher proportion of PTT is more suitable for 3000-5000 mL containers with enhanced flexibility (these containers of higher capacity typically have a substantially circular cross-section and optionally an ovoid overall shape).

According to a particular feature, the following formula is satisfied:

0.002 g/cm≦wP·eP/SB≦0.005 g/cm

where wP and eP are respectively weight and average thickness of the preform body, while SB is inner surface area of the body of the container.

Surprisingly in this range, the process is reliable because the average thickness eP of the preform may be advantageously not inferior to 2 mm, while the ratio wP/SB may be very low. This offers an advantageous compromise between quality requirements for mass production and reduction of the cost with decrease of the preform weight.

In various embodiments of the method of the invention, recourse may optionally also be had to one or more of the following dispositions:
the longitudinal stretching ratio is between approximately 3.5 and 6, and preferably between 3.5 and 4.5;
the radial stretching ratio is between approximately 4 and 9, and preferably between 4.5 and 7 (the aforementioned arrangements ensure that the preform is capable of being subjected to longitudinal stretching as well as radial stretching, making it possible to end up with a container comprising a narrow opening and a body, such as a bottle or similar, having precisely the desired shape);
the preform is obtained by mixing PET and PTT in a plasticized state and injecting the resulting mixture of PET and PTT in a mold (this step ensures that the preform is made with an homogenous mixing, optimal for allowing high stretching; a mixing device may be provided at the level of the injection nozzle);
the blowing fluid is at a pressure comprised between 20*10⁵ and 40*10⁵ Pa, and preferably between 30*10⁵ and 40*10⁵ Pa.

It is also provided, according to the invention, a preform for implementation of the method for producing containers, characterized in that the preform has a body of which the wall has a maximum thickness eP which is comprised between 1.8 mm and 3.0 mm and preferably between 2.0 mm and 2.4 mm, said body comprising, preferably essentially comprising, a mixing of two aromatic polyesters in the proportions 50-95 wt % of PET and 5-50 wt % of PTT.

A further purpose of the invention is to provide hollow containers of reduced weight, such as bottles, having physical properties adapted for storage of a still liquid beverage, preferably mineral water, the containers being further adapted to be obtained by using an injection stretch blow molding equipment and being sufficiently resistant to allow transport with superposition of the containers. The containers can also be used for storage of non beverage products such as cosmetics and detergents.

To this end, embodiments of the present invention provide a hollow plastic container comprising a narrow opening and a body having a base and at least one side wall extending longitudinally between the narrow opening and the base, obtained by stretch-blow molding an injection-molded preform, the body of the container comprising a bottom and at least one side wall, characterized in that said body comprises, preferably essentially comprises, a mixing of two aromatic polyesters in the proportions 50-95 wt % of PET and 5-50 wt % of PTT, the average thickness of said side wall being inferior to 300 μm, and preferably not superior to 120 μm.

In various embodiments of the container according to the invention, recourse may optionally also be had to one or more of the following dispositions:
the average thickness of said side wall is comprised between 50 and 200 μm, preferably between 50 and 120 μm (this arrangement ensures that high quantity of material is saved in comparison with conventional bottles or similar containers obtained by ISBM), for example between 50 and 60 μm or between 60 and 70 μm, or between 70 and 80 μm, or between 80 or 90 μm, or between 90 and less than 100 μm, or 100 μm, or between more than 100 and 110 μm, or between 110 and 120 μm;
the body essentially comprises a mixing of two aromatic polyesters in the proportions 75-95 wt % of PET and 5-25 wt % of PTT;
the inner capacity of the body is comprised in the range 250-5000 mL;
the body is obtained by stretching a preform according to the formula:

16≦L/l*D/d≦50

where
L/l is the ratio of the developed half length L of said body of the container to the developed half length l of the body of the preform, and
D/d is the ratio of the average diameter D of said body of the container to the average diameter d of the body of the preform

Other features and advantages of the invention will become apparent to those skilled in the art during the description which will follow, given by way of a non-limiting example, with reference to the appended drawings.

### BRIEF DESCRIPTION OF THE DRAWINGS

FIG. 1 is a schematic representation, in diametric section, of an example of a preform, used by the invention, associated with a schematic representation of an example of a container comprising a narrow opening and a long body, such as a bottle, flask, can or similar, capable of being obtained by means of blow molding or stretch blow molding the preform;

FIG. 2 shows a bottle obtained with a PET/PTT preform in accordance with a first preferred embodiment of the invention;

FIG. 3 shows a bottle obtained with a PET/PTT preform in accordance with a second preferred embodiment of the invention.

### DETAILED DESCRIPTION OF EMBODIMENTS

In the various figures, the same references are used to designate identical or similar elements.

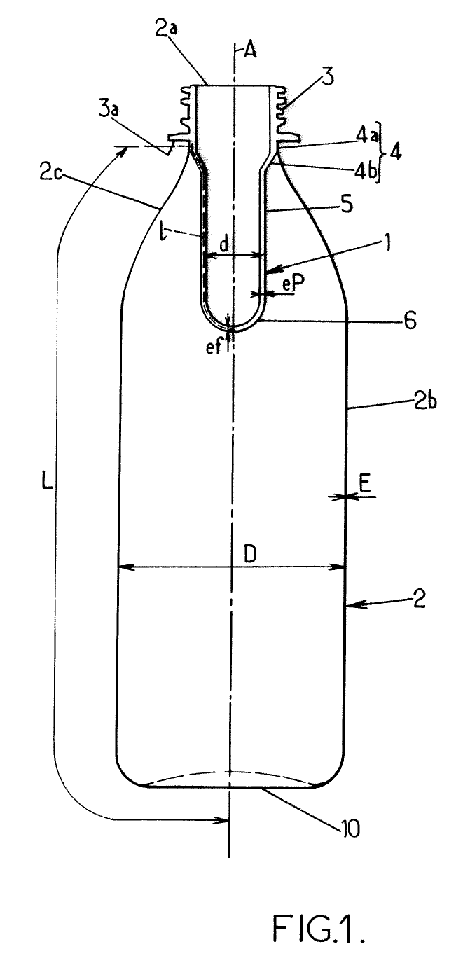

FIG. 1 shows a PET/PTT preform 1 intended for the production of a container 2 comprising a narrow opening 2a and a long body 2b, in this case a bottle, by means of a stretch blow molding process. A preform of this type comprises a neck 3 which is formed by a part present on the preform, which part is not modified during the steps of transforming the preform 1 into a container 2. The neck 3 can be closed by a means of closing off and/or distributing the flowable product contained in the body 2b of the container 2. In the extension of the neck 3, the preform 1 comprises a zone 4 of which the constituent material will form the shoulder 2c of the container 2; in the example illustrated, this zone 4 comprises a substantially cylindrical first part 4a extended by a substantially tapered second part 4b.

This second tapered part 4b is extended by two successive parts 5, 6 respectively forming the body and base of the preform 1 of which the constituent material will be found respectively on the body 2b and on the base 10 of the container 2.

In the non limitative embodiment shown in FIG. 1, the preform 1 comprises minor weight proportion of PTT and a major proportion of PET and may be conventionally designed so as to be capable of withstanding, during the blow molding or stretch blow molding process, longitudinal stretching at a ratio (i.e. ratio of the developed half length L of the long body 2b of the container 2 to the developed half length l of the body 5 of the preform 1) which is between approximately 3.5 and 6 and radial stretching at a ratio (i.e. ratio of the average diameter D of the long body 2b of the container 2 to the average diameter d of the body of the preform 1) which is between approximately 4 and 9.

The developed half length is the dimension of the neutral axis of the wall taken from the bottom 3a (in this case the lower face of the flange) of the neck 3 and the center of the base 6 for the preform 1 (shown by a dotted line in the left half of the preform 1 on FIG. 1) or the center of the base 10 for the container 2. Similarly, the average diameter is the diameter d of the part of the body 5 of the preform 1 or the diameter D of the part of the long body 2b of the container 2 taken on the respective neutral axis.

Advantageously, the production may be performed at a high rate and with high efficiency for a longitudinal stretching ratio of between approximately 3.5 and 4.5 and a radial stretching ratio of between approximately 4.5 and 7. Preferably, so that a sufficiently wide treatment window is formed to satisfy the demands of industrial mass production, it is desirable that the radial stretching ratio is greater than or at least equal to the longitudinal stretching ratio.

In these conditions, in a typical example for implementing the arrangements of the invention, the longitudinal stretching ratio is approximately 4, whilst the radial stretching ratio is approximately 5. More generally, the body 5 of the preform 1 may be subjected to an overall stretching ratio comprised between 16 and with a preform 1 having a body 5 essentially comprising 50-95 wt % of PET and 5-50 wt % of PTT. The body 5 and the neck 3 are preferably made as a single piece. This makes it possible to avoid any join or weld which may constitute a region of greater weakness.

To make it possible to ensure a production rate of the same size as that permitted by using PET preforms, it is desirable that the preform 1 made of a mixing of PET and PTT has a body 5 of which the wall has a maximum thickness eP which is less than approximately 3 mm, and preferably typically approximately 2.0 mm; it is also desirable that it has a base 6 of which the thickness of is not greater than approximately 3 mm, and preferably no greater than 2.2 mm.

In a preferred embodiment, bottles or similar containers 2 are produced by means of stretch blow molding from preforms made from a PET/PTT mixing with a proportion of PTT comprised between 5 and 50 wt %. A blend of polyethylene terephtalate (PET) and polytrimethylene terephtalate (PTT) in this composition range is homogeneously mixed and forms the plasticized material that is injected in the mold, and then cooled after being shaped into a preform in the mold. In this case, the body 5 of the preform 1 and the neck 3 are made of the same material. Those skilled in the art will appreciate that the central axis of the preform 1 defines the longitudinal direction of the container 2 at the time of its manufacture.

The body 5 of the preform 1 is then subjected to an overall stretching ratio comprised between 16 and 50, by using blowing fluid at a pressure comprised between 20*10⁵ and 40*10⁵ Pa, and preferably between 30*10⁵ and 40*10⁵ Pa.

### EXPERIMENTAL RESULTS

### Example 1

A preform 1 is injection molded by using A PET and PTT. The body 5 and the neck 3 are made as a single piece. The mixing between PET and PTT is made in such a way that the preform 1 has a body 5, here an elongated body 5, including 85 wt % of PET and 15 wt % of PTT.

TABLE A1
Preform

| | Weight | | | | |
|---|---|---|---|---|---|
| Weight | wP | Volume | Average | Developed | Thickness |
| (preform) | (body) | (body) | diameter d | half-length l | eP |
| 10 | 7.6 | 5.71 | 13.63 | 59 | 2.13 |
| (g) | (g) | (cm³) | (mm) | (mm) | (mm) |

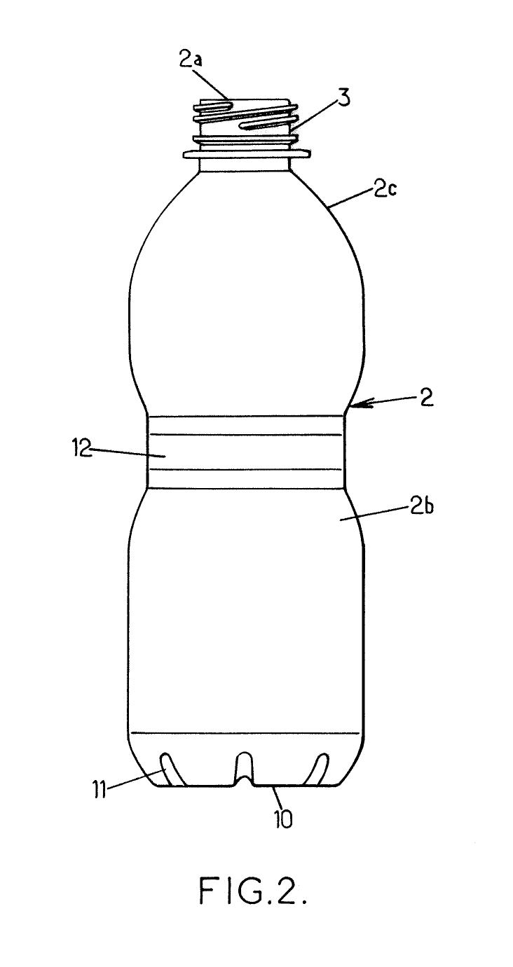

The body 2b of the preform 1 has characteristics as indicated in above table A1. This body 2b is subjected to a stretching during operation of stretch blow molding, so as to obtain a bottle having characteristics as indicated in table B1 and adapted to contain 0.5 L mineral water. For example, the general shape of such a bottle corresponds to that of the container 2 shown in FIG. 2. Features of the 0.5 L bottle and stretching ratios are reported in table B1.

TABLE B1

| 0.5 L Bottle | | | | | |
|---|---|---|---|---|---|
| | Developed | Surface | Stretching ratios | | |
| Diameter D | half-length L | area | D/d | L/l | Overall |
| 67 | 220 | 396 | 4.92 | 3.73 | 18.33 |
| (mm) | (mm) | (cm²) | | | |

The overall stretching ratio is thus greater than 18 in this case. The average thickness E of the side wall of the bottle may be 126 μm in this non-limitative example.

Tests made with a body 5 of the preform 5 essentially comprising 75-95 wt % of PET and 5-25 wt % of PTT show that the body 5 of the preform 1 can be subjected to an overall stretching ratio comprised between 16 and 25, without any modification in the steps of the ISEM method as compared when using a PET preform, so as to produce a plastic bottle (i.e. a container 2 with a narrow opening 2a and a long body 2b) with good mechanical properties. The base 10 may have a substantial wall thickness, proportionally greater than that of the remainder of the container 2 so as to support the liquid weight without any deformation. With such a composition of the preform 1, the base 10 may be obtained with a particular shape as in the PET conventional containers. With such a minor proportion of PTT, the base 10 may be shaped as shown in FIG. 2 with reinforcing ribs 11. A correct shaping of the base 10, with such reinforcing ribs 11 and an overall concavity facing the outside of the container 2 (as shown in FIG. 1), is the most difficult to implement by the stretch blow molding operation, due to the fact that the substantially greater thickness of material leads to slower stretching and more difficult shaping. Surprisingly, use of a preform 1 comprising 5-25 wt %, and preferably 5-20 wt % PTT does not affect the correct shaping of the base 10 and formability of the container 2 is good.

FIG. 2 also shows that the body 2b may be provided with an intermediate part 12 of reduced cross-section allowing a better handling of the container. Such an intermediate part typically comprises ribs or similar forms to reinforce the side wall of the body 2b, so as to resist to the pressure exerted by the hand of the user.

With a stretching ratio comprised between 16 and 25, the weight of the container 2 may be reduced and the side wall of the long body 2b has an average thickness E inferior to 200-300 μm, for instance less than 150 μm.

### Example 2

The body 2b of the preform 1 having geometry characteristics as indicated in a table A1 and having a larger proportion of PTT may be subjected to a higher stretching than according to EXAMPLE 1. The mixing between PET and PTT is made in such a way that the preform 1 has an elongated body 5 that includes 75 wt % of PET and 25 wt % of PTT.

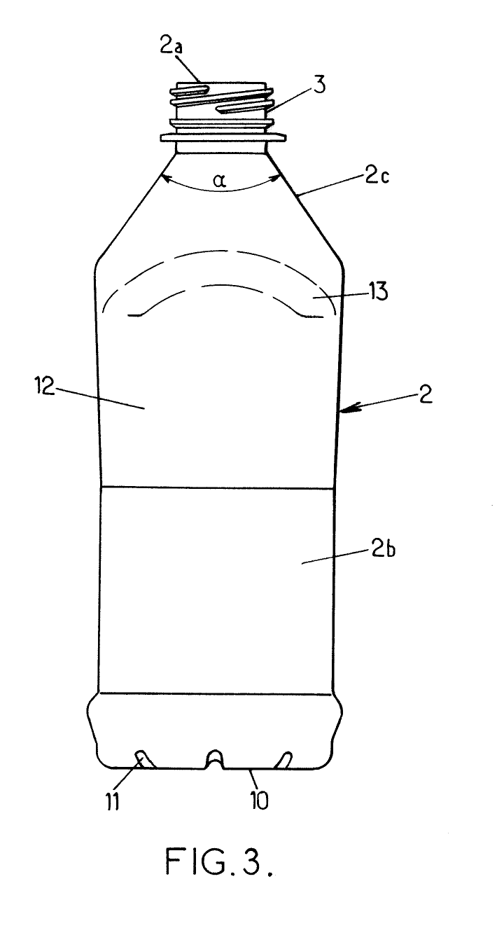

In this case, a bottle adapted to contain 1 L mineral water and having characteristics as indicated in table B2 is obtained. For example, the general shape of such a bottle corresponds to that of the container 2 shown in FIG. 3. The reinforcing ribs 11 may be of smaller size in this case. The shoulder 2c may define a tapered portion with an angle α at the reference cone apex comprised between 50 and 90°. Here, the intermediate part 12 is not of reduced cross-section but some protruding portions 13 may be provided above and/or under the level of this intermediate part 12.

Features of the 1 L bottle and stretching ratios are reported in table B2.

TABLE B2

| 1 L Bottle | | | | | |
|---|---|---|---|---|---|
| | Developed | Surface | Stretching ratios | | |
| Diameter D | half-length L | area | D/d | L/l | Overall |
| 83 | 261 | 590 | 6.09 | 4.42 | 26.94 |
| (mm) | (mm) | (cm²) | | | |

The overall stretching ratio is thus greater than 26 in this case. The average thickness E of the side wall of the bottle may be 90 μm in this non-limitative example.

More generally, when using a preform with 50-75 wt % PET and 25-50 wt % PTT, the overall stretching ratio advantageously increases so as to highly reduce the quantity of material. In this case, the side wall of the long body 2b has an average thickness E inferior to 120 μm. According to a preferred embodiment of the invention, the side wall of the long body 2b has an average thickness E that remains inferior to 200 μm, for instance comprised between 50 and 120-130 μm.

With a proportion of PTT comprised between 25 and 50 wt % and when the overall stretching ratio is comprised between 25 and 50, the material of which the side wall or side walls of the body 2b is or are made is thin and flexible enough for these walls to be able to deform locally, but also rigid enough for the container 2 to be able, under certain conditions, to maintain its initial shape obtained at the time of its manufacture. In particular, the empty container 2 having 25-50 wt % PTT does not collapse on itself when empty.

The tests above show that the following formula is satisfied:

0.002 g/cm≦wP·eP/SB≦0.005 g/cm

where wP and eP are respectively weight and average thickness of the preform body 5, while SB is inner surface area of the body 2b of the container 2.

The container 2 obtained with a preform 1 essentially comprising 50-95 wt % PET and 5-50 wt % PTT can be used for 250-5000 mL capacity, for instance to contain water or a still liquid beverage, particularly still mineral water or sparkling mineral water. Of course, the containers 2 of the present invention are not in any way limited to flat or sparkling mineral water but can be intended to contain all sorts of Plowable products, edible or inedible liquids of greater or lesser fluidity such as, for example, fruit juices, milk-based beverages, etc., and also sauces or condiments (ketchup, mustard, dressing, etc.) or non-food liquids (deionised water, cleaning products, detergents, etc.).

The present invention has been described in connection with the preferred embodiments. These embodiments, however, are merely for example and the invention is not restricted thereto. It will be understood by those skilled in the art that other variations and modifications can easily be made within the scope of the invention as defined by the appended claims, thus it is only intended that the present invention be limited by the following claims.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1.-14. (canceled)

15. A method for producing plastic containers that comprise a narrow opening and a body having a base and at least one side wall extending longitudinally between the narrow opening and the base, by stretch-blow molding an injection-molded preform, wherein the method comprises:
providing said preform with a body that comprises 50-95 wt % of PET and 5-50 wt % of PTT,
subjecting the body of the preform to an overall stretching ratio comprised between 16 and 50, said overall stretching ratio being the product of a longitudinal stretching ratio L/l and a radial stretching ratio D/d, where
L is the developed half length L of said body of the container;
l is the developed half length l of the body of the preform;
D is the ratio of the average diameter of said body of the container; and
d is the average diameter d of the body of the preform.

16. The method according to claim 15, wherein the body of the preform comprises 75-95 wt % of PET and 5-25 wt % of PTT, and in that the body of the preform is subjected to an overall stretching ratio comprised between 16 and 25.

17. The method according to claim 16, wherein the following formula is satisfied:
0.002 g/cm≦wP·eP/SB≦0.005 g/cm
where wP and eP are respectively weight and average thickness of the preform body, while SB is inner surface area of the body of the container.

18. The method according to claim 15, wherein the longitudinal stretching ratio is between 3.5 and 6.

19. The method according to claim 15, wherein the radial stretching ratio is between 4 and 9.

20. The method according to claim 15, wherein the preform is obtained by mixing PET and PTT in a plasticized state and injecting the resulting mixture of PET and PTT in a mold.

21. The method according to claim 15, wherein the blowing fluid is at a pressure comprised between 20*10⁵ and 40*10⁵ Pa.

22. The method according to claim 15, wherein the body of the preform has a wall having a maximum thickness comprised between 1.8 mm and 3.0 mm before the stretch-blow molding.

23. A method for producing plastic containers that comprise a narrow opening and a body having a base and at least one side wall extending longitudinally between the narrow opening and the base, by stretch-blow molding an injection-molded preform, wherein the method comprises:
providing said preform with a body that comprises 75-95 wt % of PET and 5-25 wt % of PTT, said preform also comprising a neck, the body having a maximum wall thickness inferior to 2.4 mm;
subjecting the body of the preform to an overall stretching ratio comprised between 16 and 25, said overall stretching ratio being the product of a longitudinal stretching ratio L/l and a radial stretching ratio D/d, where
L is the developed half length L of said body of the container;
l is the developed half length l of the body of the preform;
D is the ratio of the average diameter of said body of the container; and
d is the average diameter d of the body of the preform.

24. A preform for implementation of the method as claimed in claim 15, comprising:
a neck;
a body provided with a wall having a maximum wall thickness which is comprised between 1.8 mm and 3.0 mm,
wherein said body comprises a mixing of two aromatic polyesters in the proportions 50-95 wt % of PET and 5-50 wt % of PTT.

25. The preform of claim 24, wherein the body of the preform has a maximum wall thickness comprised between 2.0 mm and 2.4 mm.

26. A hollow plastic container comprising a narrow opening and a body having a base and at least one side wall extending longitudinally between the narrow opening and the base, obtained by stretch-blow molding an injection-molded preform, the side wall having an average thickness, wherein said body comprises a mixing of two aromatic polyesters in the proportions 50-95 wt % of PET and 5-50 wt % of PTT, the average thickness of said side wall being inferior to 300 μm.

27. The hollow plastic container of claim 26, wherein the average thickness of said side wall is comprised between 50 and 200 μm.

28. The hollow plastic container of claim 27, wherein the average thickness of said side wall is comprised between 50 and 120 μm.

29. The hollow plastic container according to claim 26, wherein said body comprises a mixing of two aromatic polyesters in the proportions 75-95 wt % of PET and 5-25 wt % of PTT.

30. The hollow plastic container according to claim 26, wherein the inner capacity of said body has an inner capacity which is comprised in the range 250-5000 mL.

31. The hollow plastic container according to claim 26, wherein said body is obtained by stretching a preform according to the formula:
16≦L/l*D/d≦50
where
L/l is the ratio of the developed half length L of said body of the container to the developed half length l of the body of the preform, and
D/d is the ratio of the average diameter D of said body of the container to the average diameter d of the body of the preform.

32. The hollow plastic container according to claim 26, containing a still liquid beverage.
